(19) United States
(12) Patent Application Publication
(10) Pub. No.: US 2002/0173986 A1
(43) Pub. Date: Nov. 21, 2002

(54) Automatic categorization of financial transactions

(75) Inventors: Christian R. Lehew, Redmond, WA (US); Leib A. Foxman, Issaquah, WA (US); Sarah Mihailovich, Vancouver (CA)

Correspondence Address: BANNER & WITCOFF LTD.,, ATTORNEYS FOR MICROSOFT, 1001 G STREET , N.W., ELEVENTH STREET, WASHINGTON, DC, 20001-4597, US

(73) Assignee: Microsoft Corporation, Redmond, WA (US)

(21) Appl. No.: 10/178,588

(22) Filed: Jun. 24, 2002

Related U.S. Application Data
(63) Continuation-in-part of application No. 09/596,637, filed on Jun. 19, 2000.

(51) Int. Cl. G06F 17/60

(52) U.S. Cl. 705/1

(57) ABSTRACT

Financial transactions are automatically categorized based on mappings of filtered transaction descriptions to financial categories. The filtered transaction descriptions may exclude extraneous characters and unwanted prefix and suffix characters. A category lookup facility tries to find a match between a stored category-description pair lookup entry and a transaction's filtered description. Upon finding a matching entry, a financial category is assigned to the transaction based on the category of the matching stored category-description pair. The category lookup facility may include stored global-user lookup data, which may be based on how multiple users of the system have previously categorized transactions.

### CROSS-REFERENCE TO RELATED APPLICATIONS

This application is a continuation-in-part of co-pending application Ser. No. 09/596,637, which was filed Jun. 19, 2000, is entitled Automatic categorization of financial transactions, and is incorporated herein by reference.

### TECHNICAL FIELD

This invention relates generally to financial transaction tracking software. More particularly, the invention provides techniques for automatically assigning a financial category to a financial transaction by filtering the transaction's description and using a category lookup facility for mapping the filtered description to a corresponding financial category.

### BACKGROUND OF THE INVENTION

Electronic representations of financial transactions often contain a string of alpha-numeric characters that describe the transaction. For instance, FIG. 2 depicts sample transactions as they typically appear on a person's monthly credit card account statement. The data contained in FIG. 2 was taken from actual credit card account statements.

Useful features of financial transaction tracking software, such as Microsoft Money 2002, include that reports may be generated, spending habits may be analyzed, and compliance with budgets may be reviewed once a person's, family's, or business's expenditures have been categorized. Conventionally, it has typically been necessary to manually enter categories for each transaction in order to take advantage of these useful features of financial transaction tracking software. Even for an individual or family with relatively few such transactions to categorize, this is a time-consuming process.

U.S. Pat. No. 5,842,185 issued to Chancey et al. purports to use data such as that shown in the column labeled “Reference” in FIG. 2 to automatically categorize financial transactions. Chancey et al. discloses translation of a numeric code, such as a Standard Industry Code (SIC), contained within a financial statement into a financial category for the transaction. The SIC code for restaurants, for instance, is 5812. As can be determined by a review of the three actual financial transaction descriptions listed in FIG. 2 for transactions in restaurants, namely, PANCAKE CAFÉ, PIZZERIA UNO #766, and CALIFORINIA CAFÉ #17, none of these descriptions contain—in any column—the numeric string “5812”, the SIC code for restaurants. Further, none of these descriptions contain any discernible numeric pattern in common with each other that is specific to only these restaurant-related entries in FIG. 2. This technique proposed by Chancey et al., therefore, does not reduce the amount of time a user would have to spend manually categorizing financial transactions.

Accordingly, there is a need for improved techniques of automatically assigning a financial category based upon an electronic representation of a financial transaction. Such a technique should execute efficiently because a financial institution may have a very large number of transactions to automatically categorize for any given time period.

### SUMMARY OF THE INVENTION

In accordance with the invention, financial transactions, which have textual transaction descriptions, are automatically categorized. The transaction descriptions are filtered to produce filtered descriptions. For a particular transaction, a category lookup facility tries to find a match between a stored category-description pair-lookup entry and the filtered description. Upon finding a matching entry, a financial category is assigned to the transaction based on the category of the matching stored category-description pair.

Filtering a transaction's description may include normalizing the transaction description by removing non-alphabetic characters from the transaction description and converting any upper-case letters to lower-case letters or vice-versa. Filtering may also include excluding unwanted prefix and/or suffix characters from the transaction description.

The category lookup facility may include stored user-level lookup data, which may be specific to a single system user; global-user lookup data, which may be based on how substantially all of the system users have categorized previous transactions; and/or keyword lookup data. The global-user data may be maintained by filtering transactions to be processed for entry into the global-user lookup data, counting instances of category-description pairings to produce associated category-description-pairing counts for category-description pairings that are unique relative to other category-description pairings, and selecting category-description pairings for inclusion into, or exclusion from, the stored global user lookup data based on the category-description pairings counts.

Category-description pairings that have associated category-description-pairing counts below a threshold value, may be excluded from the stored global-user lookup data. Category-description pairings may be selected for inclusion into the stored global user lookup data such that, if multiple category-description pairings have descriptions that are the same and categories that are different, a category-description pairing having a largest associated count value among the multiple pairings is selected for inclusion in the stored global-user lookup data and any of the multiple pairings that have relatively smaller associated count values are excluded from the global-user data.

Automatically categorizing transactions based on how multiple system users have previously categorized transactions with similar transaction descriptions advantageously increases the accuracy of the automatic-categorization results and decreases the amount of manual categorization that system users must do as time goes by and multiple system users categorize an increasing number of transactions.

Other features and advantages of the invention will become apparent through the following description, the figures, and the appended claims.

### BRIEF DESCRIPTION OF THE DRAWINGS

FIG. 1 is a schematic block diagram of a conventional general-purpose digital computing environment that can be used to implement various aspects of the invention.

FIG. 2 shows sample financial transaction data taken from actual credit card account statements.

FIG. 3 is a schematic diagram showing data flow relative to a financial transaction-description filter in accordance with an illustrative embodiment of the invention.

FIG. 4 shows data related to excluding unwanted prefixes and suffixes in accordance with an illustrative embodiment of the invention.

FIG. 5 shows a portion of a trie data structure that may be used to store global user data in accordance with an illustrative embodiment of the invention.

FIG. 6 is a schematic diagram showing processing and data flow relative to a category lookup facility for assigning financial categories to financial transactions in accordance with an illustrative embodiment of the invention.

FIG. 7 is a schematic diagram showing processing and data flow relative to a global-lookup constructor for maintaining global-user lookup data that specifies how multiple system users have assigned categories to transactions in accordance with an illustrative embodiment of the invention.

### DETAILED DESCRIPTION OF THE INVENTION

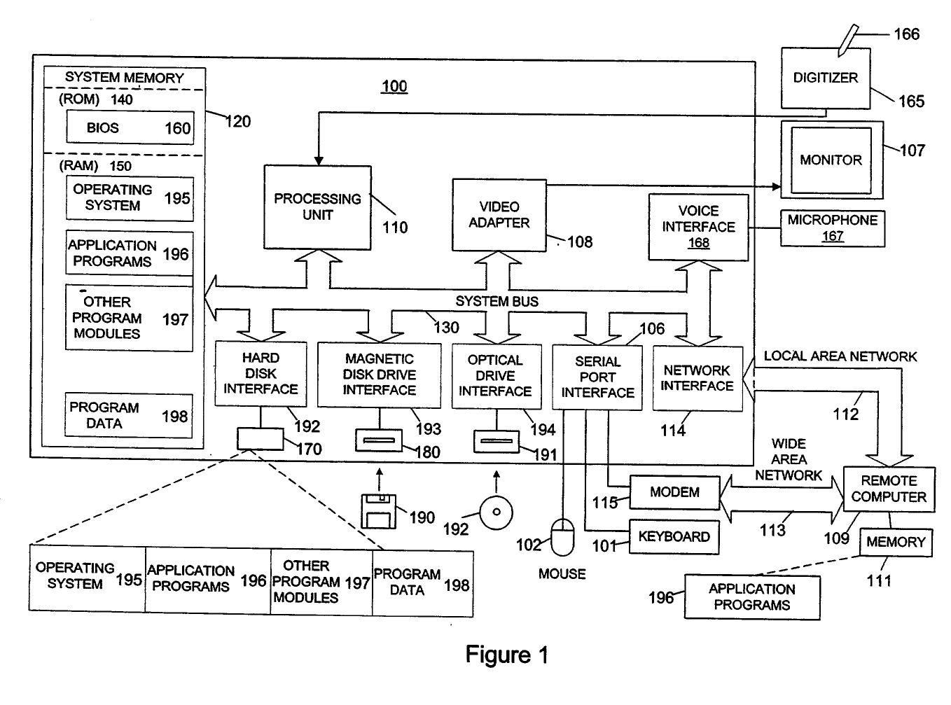

The invention may be more readily described with reference to FIGS. 1-7. FIG. 1 illustrates a schematic diagram of a conventional general-purpose digital computing environment that can be used to implement various aspects of the invention. In FIG. 1, a computer 100 includes a processing unit 110, a system memory 120, and a system bus 130 that couples various system components including the system memory to the processing unit 110. The system bus 130 may be any of several types of bus structures including a memory bus or memory controller, a peripheral bus, and a local bus using any of a variety of bus architectures. The system memory 120 includes read only memory (ROM) 140 and random access memory (RAM) 150.

A basic input/output system 160 (BIOS), containing the basic routines that help to transfer information between elements within the computer 100, such as during startup, is stored in the ROM 140. The computer 100 also includes a hard disk drive 170 for reading from and writing to a hard disk (not shown), a magnetic disk drive 180 for reading from or writing to a removable magnetic disk 190, and an optical disk drive 191 for reading from or writing to a removable optical disk 192 such as a CD ROM or other optical media. The hard disk drive 170, magnetic disk drive 180, and optical disk drive 191 are connected to the system bus 130 by a hard disk drive interface 192, a magnetic disk drive interface 193, and an optical disk drive interface 194, respectively. The drives and their associated computer-readable media provide nonvolatile storage of computer readable instructions, data structures, program modules and other data for the personal computer 100. It will be appreciated by those skilled in the art that other types of computer readable media that can store data that is accessible by a computer, such as magnetic cassettes, flash memory cards, digital video disks, Bernoulli cartridges, random access memories (RAMs), read only memories (ROMs), and the like, may also be used in the example operating environment.

A number of program modules can be stored on the hard disk drive 170, magnetic disk 190, optical disk 192, ROM 140 or RAM 150, including an operating system 195, one or more application programs 196, other program modules 197, and program data 198. A user can enter commands and information into the computer 100 through input devices such as a keyboard 101 and pointing device, such as computer mouse 102, or a trackball (not shown). Other input devices (not shown) may include a joystick, game pad, satellite dish, scanner or the like. These and other input devices are often connected to the processing unit 110 through a serial port interface 106 that is coupled to the system bus, but may be connected by other interfaces, such as a parallel port, game port or a universal serial bus (USB). Further still, these devices may be coupled directly to the system bus 130 via an appropriate interface (not shown). A monitor 107 or other type of display device is also connected to the system bus 130 via an interface, such as a video adapter 108. In addition to the monitor, personal computers typically include other peripheral output devices (not shown), such as speakers and printers. In a preferred embodiment, a pen digitizer 165 and accompanying pen or stylus 166 are provided in order to digitally capture freehand input. Although a direct connection between the pen digitizer 165 and the processing unit 110 is shown, in practice, the pen digitizer 165 may be coupled to the processing unit 110 via a serial port, parallel port or other interface and the system bus 130 as known in the art. Furthermore, although the digitizer 165 is shown apart from the monitor 107, the usable input area of the digitizer 165 may be co-extensive with the display area of the monitor 107. Further still, the digitizer 165 may be integrated in the monitor 107, or may exist as a separate device overlaying or otherwise appended to the monitor 107. Microphone 167 is coupled to the system bus via a voice interface 168 in a well-known manner.

The computer 100 can operate in a networked environment using logical connections to one or more remote computers, such as a remote computer 109. The remote computer 109 can be a server, a router, a network PC, a peer device or other common network node, and typically includes many or all of the elements described above relative to the computer 100, although only a memory storage device 111 has been illustrated in FIG. 1. The logical connections depicted in FIG. 1 include a local area network (LAN) 112 and a wide area network (WAN) 113. Such networking environments are commonplace in offices, enterprise-wide computer networks, intranets and the Internet.

When used in a LAN networking environment, the computer 100 is connected to the local network 112 through a network interface or adapter 114. When used in a WAN networking environment, the personal computer 100 typically includes a modem 115 or other means for establishing a communications over the wide area network 113, such as the Internet. The modem 115, which may be internal or external, is connected to the system bus 130 via the serial port interface 106. In a networked environment, program modules depicted relative to the personal computer 100, or portions thereof, may be stored in the remote memory storage device.

It will be appreciated that the network connections shown are exemplary and other techniques for establishing a communications link between the computers can be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

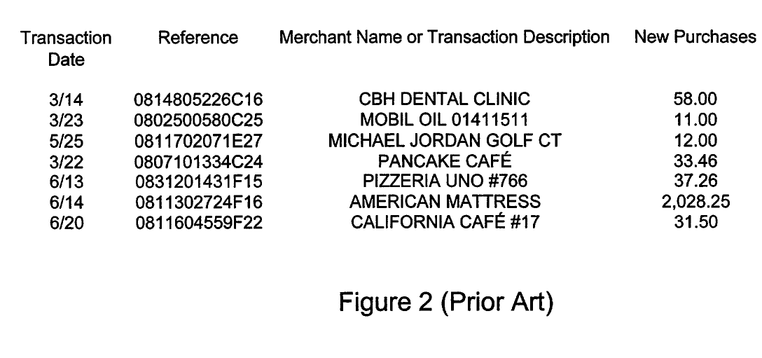

As used herein, phrases such as “financial-transaction description” and variants thereof refer to alphanumeric characters such as those shown in the column labeled “Merchant Name or Transaction Description” in FIG. 2. A financial-transaction description's alphanumeric characters typically identify the merchant or vendor, which was the payee, of a transaction.

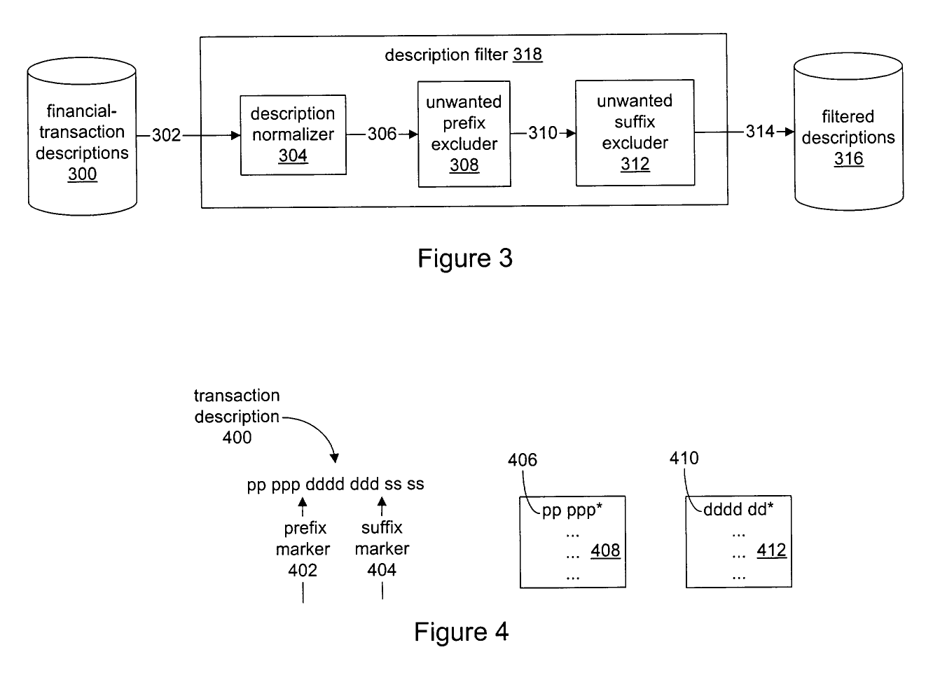

Referring to FIG. 3, financial-transaction descriptions 300 represent financial transactions to be categorized. The financial-transaction descriptions are passed, as represented by arrow 302, to description filter 318. As depicted by arrow 314, the description filter 318 outputs filtered descriptions 316.

Within the description filter 318, financial transaction descriptions, as depicted by arrow 302, may be input to a description normalizer 304. The description normalizer 304 may convert substantially all letters to a common case (lower or upper case). It may also exclude substantially all characters that are not letters, or all characters except those that are letters and numbers. Accordingly, the output of the description normalizer 304, as represented by arrow 306, may be a string of like case letters and blank spaces. The description normalizer 304 may remove numbers and punctuation marks, such as periods, slashes, new-line characters, and the like.

A normalized description, as represented by arrow 306, may be passed into an unwanted prefix excluder 308. The unwanted prefix excluder 308 may look for sets of unwanted characters, which may include spaces, appearing substantially at the beginning of a financial-transaction description. For instance, “Debit Card” might appear at the beginning of transaction descriptions from a particular financial institution. The unwanted prefix excluder 308 may remove various predetermined sets of characters that are not pertinent to automatically categorizing financial transactions in accordance with various illustrative embodiments of the invention. If the unwanted prefix excluder 308 does not encounter a set of unwanted characters, then the unwanted prefix excluder 308 may not actually exclude any portion of a transaction description.

Transaction descriptions, as represented by arrow 310, which may be normalized and which may have unwanted prefix characters removed, may be passed into an unwanted suffix excluder 312. The unwanted suffix excluder 312 may work slightly differently than the unwanted prefix excluder 308. The unwanted suffix excluder 312 may, upon recognizing a predetermined set of characters at the beginning of a financial-transaction description, exclude any unwanted suffix characters that follow the set of characters recognized by the unwanted suffix excluder 312. For instance, if “walmart” is a known suffix excluder entry, “walmart redmond wa” could have the “redomond wa” removed from the end without knowing all possible sets of characters that might follow “walmart” for every transaction description. The output of the unwanted suffix excluder 312, as depicted by arrow 314, may be stored as a set of filtered descriptions 316. If the unwanted suffix excluder 312 does not recognize a predetermined set of characters at the beginning of a financial-transaction description, then the unwanted suffix excluder 312 may not exclude any unwanted suffix characters.

An example of how the description filter 318 may process transaction descriptions will now be presented. The description normalizer may take as input a transaction description of “Checkcard Purchase Panera Bread Naperville, IL ---#552132”. The description normalizer may produce an output of “panera bread naperville il”. The description normalizer, as discussed above, may remove non-alphabetic characters, such as the comma and the characters that follow “IL”, and convert any uppercase letters to lower case letters. The unwanted prefix excluder may recognize “checkcard purchase” and exclude them for this transaction description. The unwanted suffix excluder may recognize “panera bread” and exclude the remaining characters, which are “naperville il” for this transaction description. The resulting filtered description would then be “panera bread”. Continuing with the example, if a subsequent transaction description of “Panera Bread Bolingbrook, IL” were input to the description filter 318, the resulting filtered description output by the description filter 318 would be the same as for the transaction description “Panera Bread Naperville, IL”. In this way, the description filter 318 advantageously reduces the number of filtered descriptions that the rest of the automatic-categorization system processes thereby generating efficiencies primarily by allowing the system to “recognize” more transactions, and secondarily reducing the amount of storage needed and time required for processing a given number of transactions.

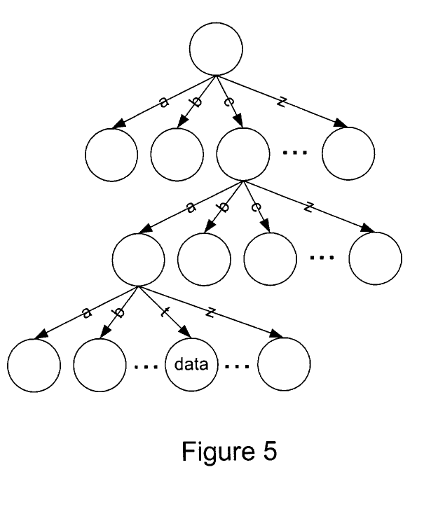

FIG. 5 depicts the concept of a trie and shows data stored for the string “cat”. To optimize the amount of time needed to search any of the data files, the data files may be serialized, a technique that allows nodes normally referenced by memory addresses to be addressed by their respective offsets from the start of the serialization. This allows for the trie to be saved to a file and mapped into memory thereby minimizing the amount of information that needs to be in physical memory at any one time. When serializing a trie, sibling nodes may be clustered together thereby shortening trie search times by promoting locality, which reduces the frequency of page swapping.

Data may be stored in either an internal node or a leaf node. Paths in a data file may often have similar suffixes. Accordingly, a data file preferably may include a table of shared suffixes such that nodes, which share a common suffix, point to the shared suffix in the shared suffix table. The nodes themselves may contain the data, which may vary, for each node.

Pointers to nodes may be represented as offsets from the start of a serialized trie data file. Such a data file may be accessed via a mapped memory file eliminating inefficiencies associated with loading and processing the entire data file. Searches in the data file may then result in no more memory pages being swapped than the length of the lookup key string. The number of page swaps may also be reduced by shared suffixes and dangling nodes, as described above.

According to an embodiment of the invention, any of the data files may be stored in any suitable trie-like data structure or as a serialized trie optionally having shared suffixes and/or truncated nodes. As will be appreciated, other suitable optimization techniques or compression techniques or both may also be used.

Referring to FIG. 4, a transaction description 400 includes unwanted prefix characters, “pp ppp,” description characters, “dddd ddd,” and unwanted suffix characters, “ss ss.” Unwanted prefix lookup data 408 may include a list of known unwanted prefix characters, such as the unwanted prefix characters 406, which may include a character to signify the end of the description. Such an end-of-description character is depicted by the “*” character in FIG. 4. The unwanted prefix lookup data 408 may be stored in a trie-like data structure that may be traversed as the transaction description 400 is parsed. Upon finding a match between any prefix characters of the transaction description 400 and an entry in the unwanted prefix lookup data 408, a prefix marker 402 may be set to separate unwanted prefix characters from other description characters. Parsing of the transaction description 400 may then continue from the location of the prefix marker 402.

Unwanted suffix lookup data 412 may include a list of known description characters, such as a set of known description characters 410, which may include a character to signify the end of the description. Such an end-of-description character is depicted by the “*” character in FIG. 4. The unwanted suffix lookup data 412 may be stored in a trie-like data structure that may be traversed as the transaction description 400 is parsed. Upon finding a match between the characters of the transaction description 400 and an entry in the unwanted suffix lookup data 408, a suffix marker 404 may be set to separate description characters from unwanted suffix characters.

As will be apparent, the description filter 318 may include any permutation or combination of the description normalizer 304, the unwanted prefix excluder 308, and the unwanted suffix excluder 312. Similarly, other suitable techniques could be used for filtering financial transaction descriptions so that insignificant variations in financial transaction descriptions may be ignored while assigning categories to transactions and storing data specifying how one or more users have assigned categories to transactions.

The filtered descriptions 316 may collapse or combine multiple financial-transaction descriptions 300 that have common portions, and portions that differ, into a single filtered description. For example, financial-transaction descriptions 300 that include different store numbers and/or different locations for related payees, such as different franchise locations, may be reduced to a single filtered description 316 for purposes of automatically categorizing transactions. For instance, financial transaction descriptions 100 may include multiple financial transaction descriptions for transactions that occurred at multiple Texaco gas stations in multiple cities. For purposes of categorizing these transactions, a single Texaco description may be used.

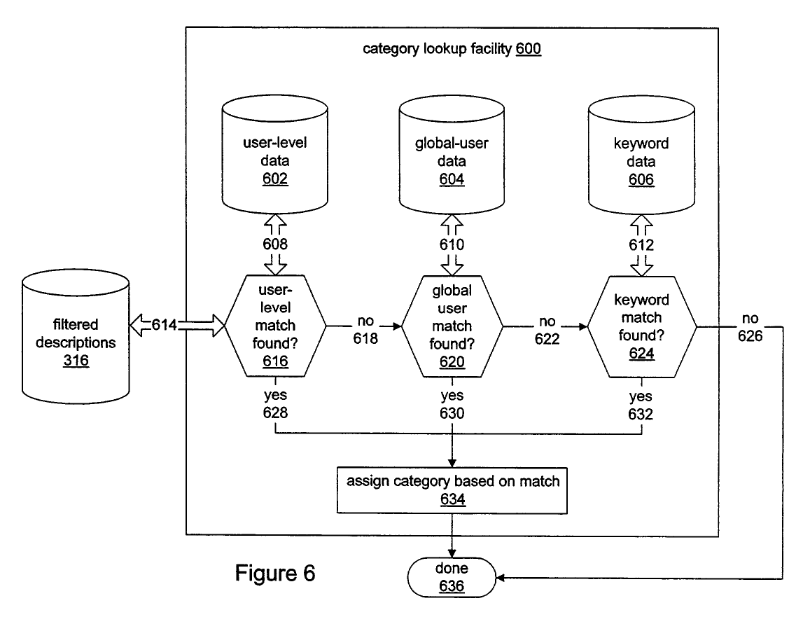

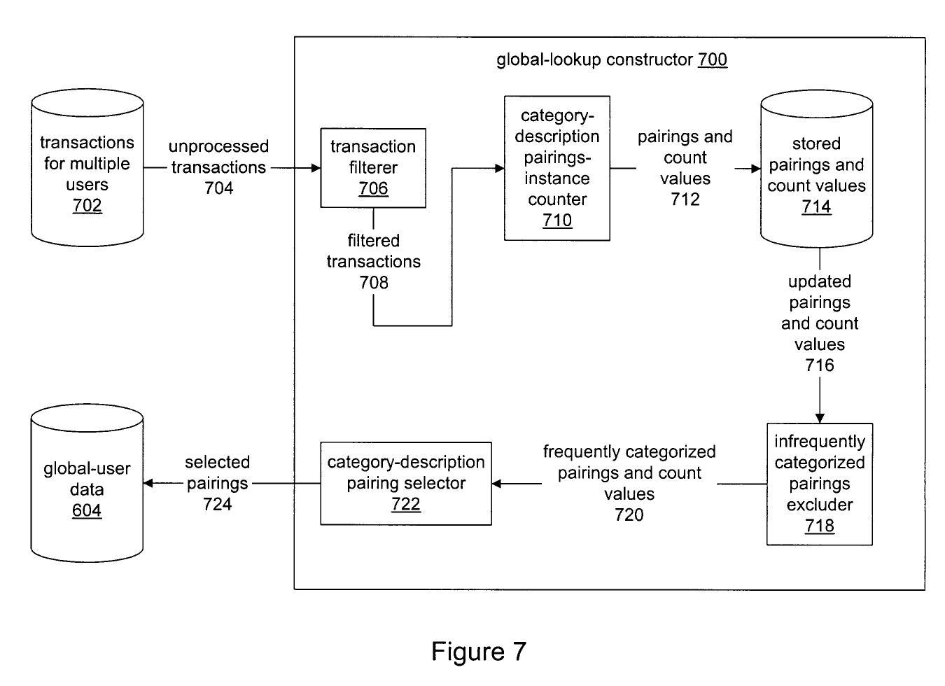

Referring to FIG. 6, filtered descriptions 316 may be input to, or read by, as indicated by double-headed arrow 614, a category lookup facility 600. The category lookup facility 600 may include one or more of the following types of data, user-level lookup data 602, global-user lookup data 604, and keyword lookup data 606. User-level data may include information specifying how a particular user has categorized previous transactions corresponding to particular filtered descriptions. Global-user data 604 may include information indicating how multiple users have categorized previous transactions of this type. In accordance with an embodiment of the invention, global-user data 604 may specify how substantially all automatic-categorization-system users have previously categorized such transactions. Techniques for constructing and/or maintaining global user data 604 are discussed below in connection with FIG. 7. Keyword data 606 may specify how the category lookup facility 600 will map keywords, which may appear in transaction descriptions, into category assignments.

As depicted at 616, the category lookup facility 600 may look for a match between a filtered description and an entry in the user-level data 602, as depicted by double-headed arrow 608. Upon finding a match, the category lookup facility 600 assigns a category to the transaction based on the match, as depicted by 628 and 634. For instance, if user-level data 602 is being searched for a match with a filtered description of “panera bread”, then if the user has previously categorized any transactions having transactions descriptions that correspond to this filtered description, then the category lookup facility may assign a category to the “panera bread” transaction in accordance with how the user categorized the previous corresponding transaction.

If a user-level-data match is not found, as depicted by 618, the category lookup facility 600 may look for a match between a filtered description and an entry in the global-user data 604, as depicted by double-headed arrow 610. Upon finding a match, the category lookup facility 600 assigns a category to the transaction based on the match, as depicted by 630 and 634. Continuing with the “panera bread” example, if any user has previously categorized any transactions having transactions descriptions that correspond to this filtered description, then the category lookup facility may assign a category to the “panera bread” transaction in accordance with how the users have categorized the previous corresponding transactions.

If a global-user-data match is not found, as depicted by 622, the category lookup facility 600 may look for a match between a filtered description and an entry in the keyword data 606, as depicted by double-headed arrow 612. Upon finding a match, the category lookup facility 600 assigns a category to the transaction based on the match, as depicted by 632 and 634. If a keyword-data match is not found, as depicted by 626, processing may finish, as depicted at 636, without a category being assigned to the transaction. Continuing with the “panera bread” example, if either “panera” or “bread” appear in the keyword data 606, then a category corresponding to either of these terms may be assigned.

As will be apparent, any permutation or combination of steps 616, 620, and 624 may be included within a category lookup facility 600 in accordance with various illustrative embodiments of the invention.

FIG. 7 schematically depicts a global-lookup constructor 700 for constructing and/or maintaining global user data 604. The global-lookup constructor 700 may run periodically, such as once per day. Transaction filterer 706 may access transactions from multiple users, as depicted by 702 and 704. The transaction filterer 706 may filter unprocessed transactions of substantially all users of an automatic-categorization system. For a large financial institution, the number of such system users, and the corresponding number of transactions, may be quite large.

The transaction filterer 706 may exclude transactions deemed undesirable in accordance with one or more predetermined criteria. For instance, transactions that have already been processed by the global-lookup constructor 700 may be ignored. This may be implemented by associating a transaction-processed flag with each transaction. Such a flag may be initially cleared and may be set once the global-lookup constructor 700 processes the corresponding transaction. The transaction filterer 706 may ignore transactions that were categorized by keywords. Similarly, the transaction filterer 706 may ignore transactions that were categorized using global-user data 604 to prevent the global-lookup constructor 700 from essentially looping its output back into itself as input. The transaction filterer 706 may ignore transactions that were categorized with customized non-standard categories. The transaction filterer 706 may ignore transactions having no descriptions. As will be apparent, other suitable criteria may also be used for excluding data for particular transactions from the global-user data 604.

A category-description pairings-instance counter 710 counts and stores instances of category-description pairings. If the category-description pairings-instance counter 710 encounters a category-description pairing that it has not already encountered, it may create a new entry—having an instance count value of 1—for the category-description pairing in a database of stored pairings and count values 714. If the category-description pairings-instance counter 710 encounters a category-description pairing that it has already encountered, it may then simply increment the count value for that pairing in the database of stored pairings and count values 714. In this way, stored pairings and count values 714 represent how many times category-description pairs occur, wherein the category-description pairs are unique relative to other category-description pairs. For instance, the filtered description “meijer” could be categorized for some transactions as food and for other transactions as household expenses. Under these circumstances, a first category-description pairing of “meijer/food” could have its own instance count value, and “meijer/household” could have its own separate instance count value. Accordingly, multiple entries in the stored pairings and count values 714 may have the same filtered description, but different paired categories, and associated count values that may differ.

An infrequently categorized pairings excluder 718 may accept as input updated pairings and count values 716. The pairings and count values are referred to as updated to indicate that they may include pre-existing data from the stored pairings and count values 714 plus any newly added pairings and count values 712 associated with filtered transactions 708. The infrequently categorized pairings remover 718 may remove category-description pairings for which an associated instance counter in the stored pairings and count values 714 indicates that the category-description pairings-instance counter 710 has counted fewer than a threshold number of instances of that pairing.

Category-description pairings selector 722 may then accept as input the frequently categorized pairings and count values 720, which was output by the infrequently categorized pairings excluder 718. The category-description pairings selector 722 may then select category-description pairings in any suitable way for inclusion in the global-user data 604. For instance, if the category-description pairing selector 722 encounters multiple category-description pairings that have the same filtered description and different categories, the category-description pairing selector 722 may select the pairing with the highest instance count value for inclusion in the global-user data 604, and pairings with count values that are not as high may be excluded from the global-user data 604. As will be apparent, other suitable techniques for selecting data for inclusion could also be used. For instance, categories could be assigned to transactions based on the relative frequency with which users have assigned particular categories to transactions having corresponding filtered description. For example, if “meijer/food” had an instance count that was twice as high as the instance count value for “meijer/household”, upon encountering filtered descriptions of “meijer”, the category lookup facility 600 could assign a category of “food” to twice as many of these transactions as the number for which it assigns a category of “household.” Further, in this example, the category lookup facility 600 could assign a category of food to some of these transactions twice as often as it assigns a category of “household” to others of these transactions. A user may also be presented with alternative categorization candidates, which may include an indication of how often—a percentage basis, for instance—other system users have assigned various categories to previous corresponding transactions. A user may also be provided with an indication of the data source (i.e., user-level, global, or keyword data) used for automatically categorizing a transaction.

The category-description pairing selector may store selected pairings 724 in the global-user data 604, which may be stored in the form of a trie data structure, details and optional features of which are discussed above in connection with FIG. 5.

Various methods of the invention may be implemented in software that may be stored on computer disks or other computer-readable media.

We claim:

1. A method of automatically categorizing a financial transaction having a transaction description, the method comprising:
filtering the transaction description to produce a filtered transaction description;
determining whether the filtered transaction description matches a category lookup-facility entry; and
upon finding a match between the filtered description and a category lookup-facility entry, assigning a financial category to the transaction based on the match.

2. The method of claim 1, wherein filtering the transaction description includes normalizing the transaction description by removing non-alphabetic or non-alphanumeric characters from the transaction description.

3. The method of claim 2, wherein normalizing the transaction description includes making all alphabetic characters of the transaction description a single case (upper or lower).

4. The method of claim 1, wherein filtering the transaction description includes excluding unwanted prefix characters from the transaction description.

5. The method of claim 4, wherein excluding unwanted prefix characters includes searching for strings of unwanted prefix characters by traversing a trie-like data structure of stored unwanted prefix characters while parsing the transaction description.

6. The method of claim 5, wherein excluding unwanted prefix characters includes setting a prefix exclusion marker to distinguish unwanted prefix characters from filtered description characters.

7. The method of claim 6, wherein filtering the transaction description includes excluding unwanted suffix characters from the transaction description.

8. The method of claim 7, wherein excluding unwanted suffix characters includes searching for strings of expected filtered description characters by traversing a trie-like data structure of stored expected filtered description characters while parsing the transaction description.

9. The method of claim 8, wherein excluding unwanted suffix characters includes setting a suffix exclusion marker to distinguish filtered description characters from unwanted suffix characters such that, for setting the prefix exclusion marker and the suffix exclusion marker, the transaction description is parsed a single time.

10. The method of claim 1, wherein the category lookup facility includes stored user-level lookup data.

11. The method of claim 1, wherein the category lookup facility includes global-user lookup data.

12. The method of claim 11, wherein the stored global-user lookup data is maintained by:
filtering transactions to be processed for entry into the stored global-user lookup data;
counting instances of category-description pairings to produce associated category-description-pairing counts for category-description pairings that are unique relative to other category-description pairings; and
selecting category-description pairings for inclusion into, or exclusion from, the stored global user lookup data based on the category-description pairings counts.

13. The method of claim 12, further comprising: excluding from the stored global lookup data category-description pairings that have associated category-description-pairing counts below a threshold.

14. The method of claim 12, wherein category-description pairings are selected for inclusion into the stored global user lookup data such that, if multiple category-description pairings have descriptions that are the same and categories that are different, a category-description pairing having a largest associated count value among the multiple pairings is selected for inclusion in the stored global user lookup data and any of the multiple pairings that have relatively smaller associated count values are excluded from the global user data.

15. The method of claim 1, wherein the category lookup facility includes stored keyword lookup data.

16. A computer-readable medium having computer-executable instructions for performing the steps recited in claim 1.

17. A computer system that automatically categorizes financial transactions, the system comprising:
a description filter that accepts as input financial transaction descriptions and produces as output filtered descriptions;
a category lookup facility that, upon finding a match between a filtered description and stored lookup facility data, assigns a financial category to the filtered description; and
wherein the category lookup facility includes global-user data that indicates how a plurality of users have previously assigned financial categories to transactions.

18. The computer system of claim 17, wherein the description filter includes a description normalizer that excludes characters other than lower case letters and blank spaces from the filtered descriptions.

19. The computer system of claim 17, wherein the description filter includes a prefix excluder that excludes unwanted prefix characters from the filtered descriptions.

20. The computer system of claim 17, wherein the description filter includes a suffix excluder that excludes unwanted suffix characters from the filtered descriptions.

21. The computer system of claim 17, wherein the category lookup facility includes user-level data that specifies how a user has previously assigned financial categories to transactions.

22. The computer system of claim 17, wherein the category lookup facility includes keyword data that specifies how keywords in filtered descriptions map to financial categories.

23. The computer system of claim 17, wherein the global-user data excludes filtered description-and-financial category pairings for which fewer than a threshold number of instances have been counted.

24. The computer system of claim 17, wherein the filtered description-and-financial category pairings have been selected for inclusion into the global-user data such that, if multiple filtered description-and-financial category pairings have common filtered descriptions but different financial categories, a filtered description-and-financial category pairing is selected from among the multiple filtered pairings such that a pairing that has a largest associated count value is included in the global-user data and any remaining pairings that have relatively smaller associated count values are excluded from the global-user data.

25. A computer readable medium storing computer-readable global-user data comprising: a plurality of filtered financial transaction description-and-financial category pairings based on how a plurality of system users have assigned financial categories to financial transactions, wherein:
the filtered description-and-financial category pairings are based on a set of transactions that has been filtered to exclude transactions in accordance with one or more predetermined criteria;
each filtered description-and-financial category pairing has a corresponding count value that indicates how often the pairing's filtered description has been categorized with the pairing's financial category;
the filtered description-and-financial category pairings have been filtered to exclude pairings that do not have associated count values that exceed a threshold; and
the filtered description-and-financial category pairings have been selected for inclusion into the global-user data such that, if multiple filtered description-and-financial category pairings have common filtered descriptions but different financial categories, a filtered description-and-financial category pairing is selected for inclusion in the global-user data from among the multiple filtered pairings such that a pairing that has a largest associated count value is included in the global-user data and any remaining pairings that have relatively smaller associated count values are excluded from the global-user data.

26. The computer readable medium of claim 25, wherein the one or more predetermined criteria include a criterion for excluding pairings corresponding to transactions categorized using stored keyword data.

27. The computer readable medium of claim 25, wherein the one or more predetermined criteria include a criterion for excluding pairings corresponding to transactions categorized using stored global-user data.

28. The computer readable medium of claim 25, wherein the one or more predetermined criteria include a criterion for excluding pairings corresponding to transactions categorized with a customized non-standard category.

29. The computer readable medium of claim 25, wherein the global-user data is stored in a trie data structure.
